(19) United States
(12) Patent Application Publication
(10) Pub. No.: US 2009/0133283 A1
(43) Pub. Date: May 28, 2009

(54) Relay commutation sequence for multiple element heating system

(76) Inventors: Michael Paul Ricklefs, Webster City, IA (US); Brian Douglas Ripley, Webster City, IA (US); Sean Florian Myers, Ames, IA (US); Scott David Tosten, Duncombe, IA (US); Brian James Kierzek, Webster City, IA (US); Ian Tomas Fitzgerald, Webster City, IA (US)

Correspondence Address: BANNER & WITCOFF, LTD.;ATTORNEYS FOR CLIENT NOS. 006912 AND 026912, 1100 13th STREET, N.W., SUITE 1200, WASHINGTON, DC, 20005-4051, US

(21) Appl. No.: 11/945,426

(22) Filed: Nov. 27, 2007

(51) Int. Cl. F26B 3/04; F26B 11/04

(52) U.S. Cl. 34/476; 34/543; 34/595

(57) ABSTRACT

To control a temperature of a dryer system, particularly a laundry dryer, an ON/OFF relay control is employed to switch heater loads. A plurality of heating elements is used in order to more precisely regulate the temperature inside the dryer system. Further, a heating control system that includes a plurality of symmetric heating elements and a control circuit is used to maintain equal distribution of relay switching loads, resulting in an extended lifetime of each individual relay. Asymmetric heating elements may also be used.

### FIELD OF THE INVENTION

The present invention relates generally to heating systems in laundry dryers. More specifically, the invention provides a relay control system for a plurality of heating elements in a dryer, to evenly distribute load across the heating elements.

### BACKGROUND OF THE INVENTION

Dryer systems, particularly laundry dryers, include heating elements. The heating elements heat air from an intake prior to the air being introduced to a rotatable drum of the dryer system where materials such as clothes are introduced and dried. Some dryer systems have employed an ON/OFF relay control to switch the heating elements ON and OFF in order to control the temperature of the dryer systems.

Known drying systems have mostly employed only a single heating element with ON/OFF relay control or two heating elements with a relay controlled primary element and a relay or TRIAC (TRIode for Alternating Current) controlled secondary element. At least one known dryer system has described using up to three heating elements. However, the problem with the system described in the prior art is that it lacks a relay control of the heating elements that would allow a prolonged lifetime of the relays associated with the heating elements. The relays burn out quicker than they should as a result of large loads, such as electric current, that they carry.

### BRIEF SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

There is a need for a relay ON/OFF control technique in dryer systems that allow longer relay lifetimes. A dryer system with a plurality of symmetric heating elements, where a control circuit with an ON/OFF relay control of the heating elements equally distributes the switching load of the individual relays, would result in each individual relay lifetime being extended.

Aspects of the invention provide a method and apparatus for controlling heating systems, particularly in dryer systems, such as laundry dryers, that allow for longer relay lifetimes of heating element relays. For example, an aspect of the invention provides a dryer system with a plurality of symmetric heating elements, where a control circuit with an ON/OFF relay control of the heating elements equally distributes the switching load of the individual relays, thereby resulting in extending the lifetime of each individual relay.

According to one or more aspects of the invention, a control circuit controls a relay ON/OFF control operation of a plurality of heating elements in a manner that the lifetime of each individual relay is extended, wherein the relay ON/OFF control is a method of using relays to switch the heating elements ON or OFF, based on a determined or acceptable temperature level.

In one or more aspects of the invention, asymmetrical heating elements may be used to provide at least eight distinct heat levels, including a level for when no heat is supplied by any of the heating elements.

In another aspect of the invention, symmetrical heating elements may be used to provide at least four distinct heat levels, including a level for when no heat is supplied by any of the heating elements.

In further aspects of the invention, a combination of symmetrical and asymmetrical heating elements may be used to provide at least six distinct heat levels, including a level for when no heat is supplied by any of the heating elements.

### BRIEF DESCRIPTION OF THE DRAWINGS

A more complete understanding of the features described herein and the advantages thereof may be acquired by referring to the following description by way of example in view of the accompanying drawings, in which like reference numbers indicate like features, and wherein:

FIG. 1 shows an illustrative front perspective view of a dryer system that may be used in accordance with aspects of the present invention.

FIG. 2 shows an illustrative side schematic cross-sectional view of the illustrative dryer system of FIG. 1, showing a reversing drum.

FIG. 3 shows an illustrative heating control system, including a control circuit for controlling the operation of heating elements of a dryer system.

FIG. 4A shows a flowchart used to illustrate an ON/OFF relay control of heating elements.

FIG. 4B shows a flowchart used to illustrate the operation of the ON/OFF control of FIG. 4A when a heater is activated or added.

FIG. 4C shows a flowchart used to illustrate the operation of the ON/OFF control of FIG. 4A when a heater is deactivated or dropped.

### DETAILED DESCRIPTION OF THE INVENTION

In the following description of the various embodiments, reference is made to the accompanying drawings, which form a part hereof, and in which is shown by way of illustration, various embodiments in which the invention may be practiced. It is to be understood that other embodiments may be utilized and structural and functional modifications may be made without departing from the scope and spirit of the present invention.

In order to mitigate relay burn-outs in heating control systems in accordance with the present invention, a control circuit for controlling a plurality of heating elements is provided in heating control systems, particularly in laundry dryer systems. The heating control system can be used in any dryer system, such as gas powered laundry dryer, electric powered laundry dryer, stackable laundry dryer, free standing front loading laundry dryer, and the like.

### An Illustrative Dryer System

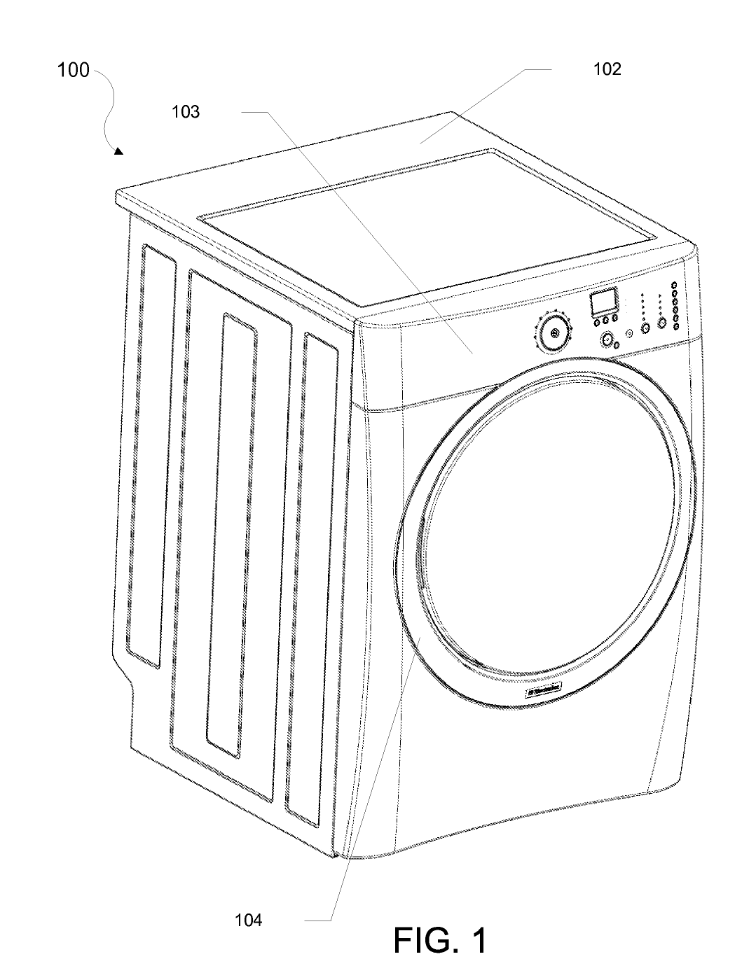

FIG. 1 provides an example of a laundry dryer system 100 in which one or more aspects of the present invention may be embodied. As shown, dryer 100 includes a housing 102, which generally includes a door 104 covering an access port (not shown in FIG. 1).

Dryer 100 further includes a user interface 103. The user interface 103 generally includes one or more buttons, knobs, other inputs, displays and the like, that are used to select a dryer cycle and/or to select a desired temperature level or threshold. A desired temperature level or threshold may be based on the type or quantity of material being dried. In addition, the dryer 100 includes all computer systems, including hardware and software, necessary for dryer cycle selection and control as described herein. Such systems may include a processor, memory, and so forth.

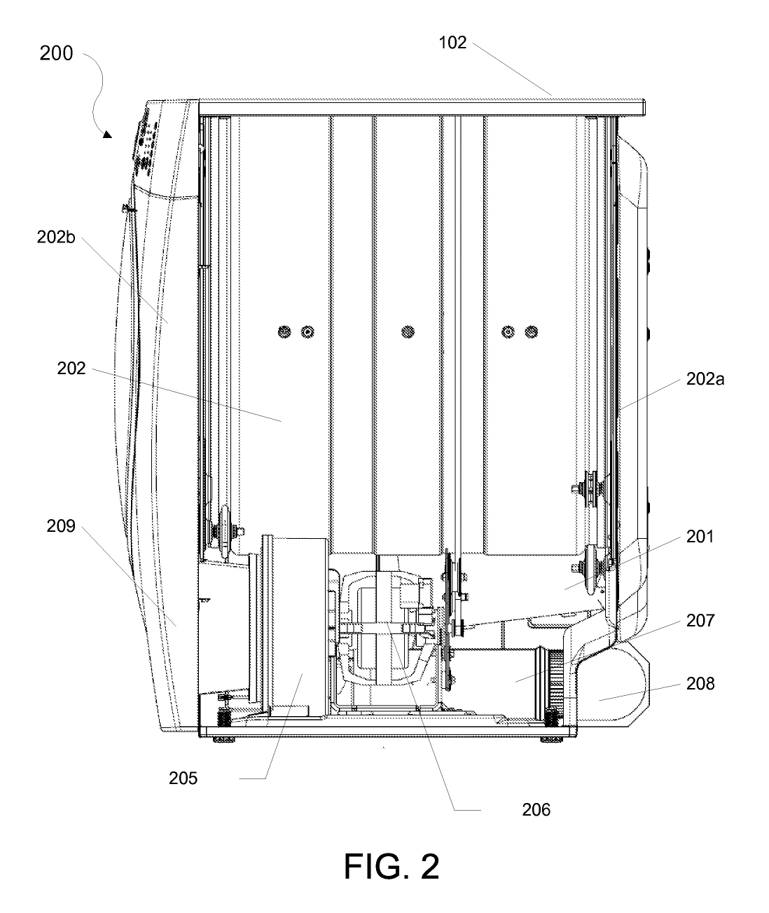

In an illustrative embodiment of FIG. 2, the housing 102 generally contains mechanical systems for a typical dryer function. For example, the housing 102 includes a heating system 201, which includes heating elements, a rotatable drum 202 in which clothes are contained during a dryer cycle, a drive system 206 configured to rotate the rotatable drum 202, exhaust tube 207, vent 208, and air duct 209.

Referring to FIGS. 1 and 2, the illustrative dryer system 200 generally functions by running air from an intake through the heating system 201. The heating system 201 heats the air prior to the air being introduced to the rotatable drum 202. Once the air is heated, the air is passed through the clothes being tumbled in the rotatable drum 202. The air is introduced to the drum 202 at the rear 202a of the rotatable drum 202 and flows from the rear 202a to the front 202b of the rotatable drum 202. The air may then flow through an air grill (not shown in FIG. 2) located in the front bulkhead near the front end 202b of the rotatable drum 202. Once the air passes through the air grill it enters an air duct that includes a lint trap (not shown) or screen, which removes any lint or other particles that may have passed from the clothes being dried to the air. The air then flows through an exhaust tube 207 to a vent 208 where it generally exits the dryer and eventually the home of the user. A fan or blower 205 is generally used to circulate the air through the dryer 200. The blower 205 may be positioned in the air flow path to facilitate air flow and in some arrangements, the blower 205 may be positioned downstream of a lint trap (not shown).

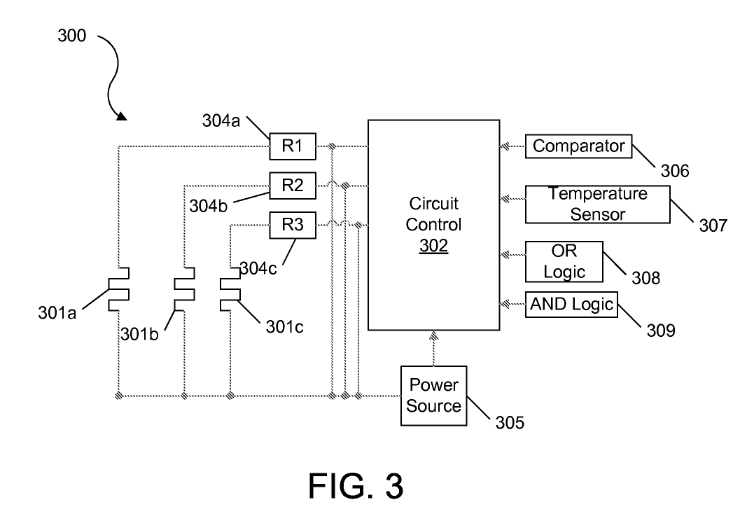

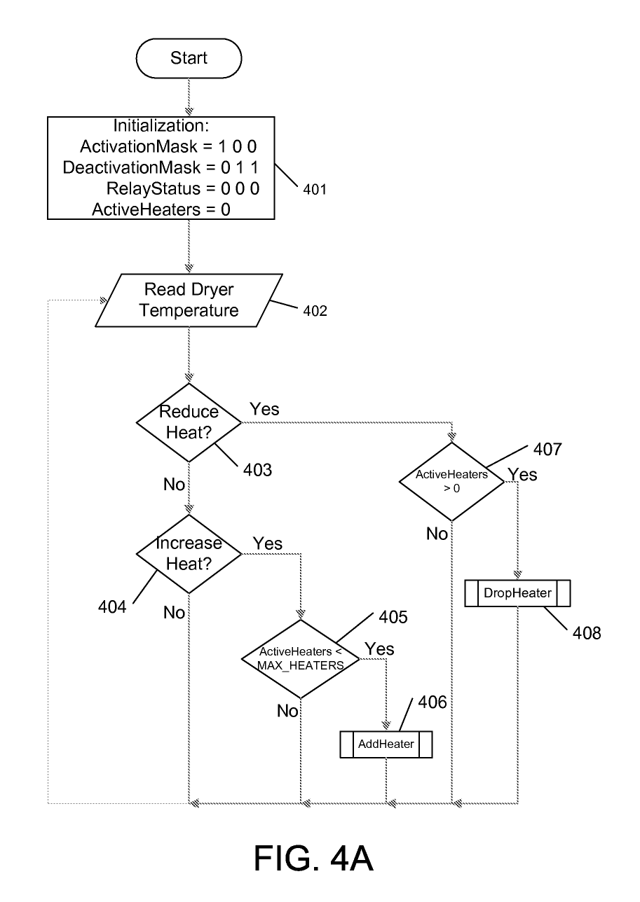

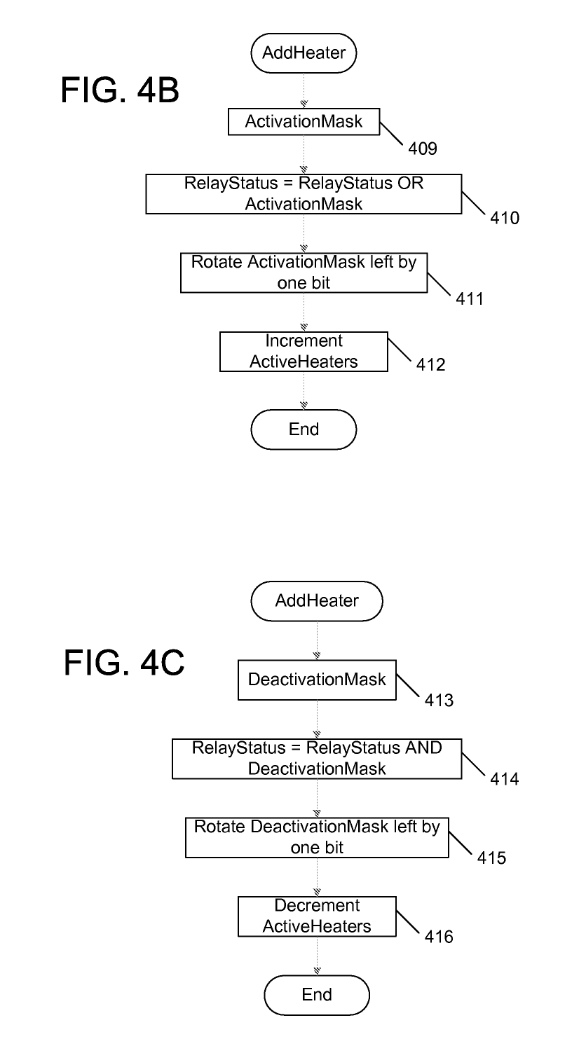

The Heating System. With reference to FIGS. 3 and 4, an illustrative embodiment of a heating control system 300 and its control process is shown in accordance with one or more aspects of the present invention. The heating control system 300 includes heating elements 301a, 301b, and 301c, relays 304a, 304b, and 304c for switching the heating elements, a circuit control (or control logic) 302 for controlling the operation of the relays 304a, 304b, and 304c and the heating elements 301a, 301b, and 301c, and a power source 305 for operating the circuit control 302. In addition, the heating control circuit 302 may include or use a comparator 306, a temperature sensor 307, OR logic 308 and AND logic 309, all discussed with respect to FIG. 4. The circuit control 302 further includes processing capabilities for making determinations based on set thresholds, such as temperature thresholds. The temperature sensor 307 may include one or more thermostats, thermistors, or other temperature measurement devices used in one or more locations in the dryer system 200, for example, in an inlet and/or exhaust of the dryer system 200.

The heating elements 301a, 301b, and 301c can either be symmetrical, where the heating elements 301a, 301b, and 301c are treated identically by the circuit control 302, or asymmetrical, where the heating elements are treated differently by the circuit control 302. For symmetrical heating elements, the heating elements 301a, 301b and 301c are of equal sizes and for asymmetrical heating elements, at least two of the heating elements 301a, 301b, and 301c are of different sizes, where a size of a heating element is associated with the power rating or heat output of the heating element.

The sizing of the heating elements 301a, 301b, and 301c may increase the flexibility and precision of the level of heat supplied to a dryer system. The circuit control 302 operates the heating elements using ON/OFF relay control. In the ON/OFF relay control, the relays 304a, 304b, and 304c, switch their corresponding heating elements ON/OFF under control of instructions by the circuit control 302, where the relays 304a, 304b, and 304c correspond to the heating elements 301a, 301b and 301c, respectively.

If the heating elements 301a, 301b, and 301c are asymmetrical, the different sizing of the elements 301a, 301b, and 301c provides up to eight distinct heat levels, including a level for when no heat is supplied by any of the heating elements. Table 1 illustrates these eight distinct heat levels. As expected, heating elements exceeding three can provide more than eight distinct heat levels. On the other hand, if the heating elements 301a, 301b, and 301c are symmetrical, four distinct heat levels are achieved, including a level for when no heat is supplied by any of the heating elements.

TABLE 1

| Heater Level | Heater 1 | Heater 2 | Heater 3 |
|---|---|---|---|
| 0 | OFF | OFF | OFF |
| 1 | OFF | OFF | ON |
| 2 | OFF | ON | OFF |
| 3 | OFF | ON | ON |
| 4 | ON | OFF | OFF |
| 5 | ON | OFF | ON |
| 6 | ON | ON | OFF |
| 7 | ON | ON | ON |

Table 2 illustrates these four distinct heat levels. Again, heating elements exceeding three can provide more than four distinct heat levels, where heat level 1 is achieved by any one heater ON and heat 2 is achieved by any two heaters ON. Although making the heating elements 301a, 301b, and 301c symmetrical reduces the degree of flexibility in the temperature regulation, it allows for a longer life span of each of the heater element relays. This is because using symmetrical heating elements allows for equal distribution of the number of relay commutations for a plurality of heating elements. Over the lifetime of a dryer system with the heater control system 300 using a plurality of symmetrical heating elements, it is expected that the relays will be within one period of ON/OFF of each other, so that about the same number of activation or switching is achieved for each relay, thereby reducing relay failures during the lifespan of the dryer.

TABLE 2

| Heater Level | Heater 1 | Heater 2 | Heater 3 |
|---|---|---|---|
| 0 | OFF | OFF | OFF |
| 1 | OFF | OFF | ON |
| 2 | OFF | ON | ON |
| 3 | ON | ON | ON |

In another example, a combination of symmetrical and asymmetrical heating elements may be used in a dryer system. For example, two of the heating elements 301a, 301b, and 301c, may be symmetrical while a third may be asymmetrical with respect to the two symmetrical elements. This combination results in six distinct heat levels as is illustrated in table 3.

TABLE 3

| Heater Level | Heaters 1 and 2 | Heater 3 |
|---|---|---|
| 0 | Both OFF | OFF |
| 1 | Both OFF | ON |
| 2 | 1OFF, 1ON | OFF |
| 3 | Both ON | OFF |
| 4 | 1OFF, 1ON | ON |
| 5 | Both ON | ON |

The Heating System Control Process. Referring to FIGS. 4A-4C, a flow chart illustrates the logic for a control process for controlling a plurality of symmetrical heating elements, such as the heating elements described with respect to FIG. 3. The logic illustrated in FIG. 3 and described below may be implemented in software, hardware, application specific integrated circuits (ASIC), field-programmable gate arrays, or other logic-capable systems. At the start of the control process, the following heater parameters are initialized at step 401: ActivationMask, DeactivationMask, RelayStatus, and ActiveHeaters. The ActivationMask represents a bitmap indicating the next heater to be activated, where the first bit represents heater 1, the second bit represents heater 2, etc., and a bit value of 1 indicates the heater should be activated when the ActivationMask is applied, and a bit value of 0 indicates that the heater should remain in whatever state it is presently in when the ActivationMask is applied.

DeactivationMask represents a bitmap indicating the next heater to be deactivated, where the first bit represents heater 1, the second bit represents heater 2, etc., and a bit value of 0 indicates the heater should be deactivated when the DeactivationMask is applied, and a bit value of 1 indicates that the heater should remain in whatever state it is presently in when the DeactivationMask is applied. RelayStatus is a bitmap representation of whether each relay is presently in an ON (bit value=1) or OFF (bit value=0) state. ActiveHeaters is an integer counter indicating the number of heaters that are ON (that is the number of heating elements supplying heat to the dryer system). The initial values assigned to the heater parameters may be published or stored in a memory of the control circuit 302, an external memory module attached to the control circuit 302, or a control module of the heating control system 300 for a possible future use.

The ActivationMask acts as a heater activation parameter, and stores information usable to ensure substantially equal activation of each symmetrical heating element. Substantial equal activation refers to each relay being activated in a circular sequence to ensure that no relay has been commuted more than any other relay by more than once (or some other predetermined discrepancy value) over some predetermined period of time, for example, since the dryer was last plugged in and/or powered on, manufactured, per cycle, etc.

In initialization step 401, bit values of equal width (equal number bits) are assigned to each of ActivationMask, DeactivationMask, and RelayStatus, where the bit-width is determined by the number of available symmetrical heating elements. In the initialization step 401, the three-bit value assignment for each of ActivationMask, DeactivationMask, and RelayStatus, as reproduced below, indicates that there are three available heating elements in the present example:

$$\begin{matrix}ActivationMask = 100 \\ DeactivationMask = 011 \\ RelayStatus = 000 \\ ActiveHeaters = 0\end{matrix}$$

Because the RelayStatus is 000 and ActiveHeaters=0, it is apparent that, initially, all the relays are turned OFF and there is no heating element that is switched ON or supplying heat.

In step 402, temperature sensor 307 takes a temperature reading of a dryer system, such as a laundry dryer. The temperature reading may be performed, for example, in the drum of the dryer or in the exhaust air stream and/or the inlet air stream. Because all the heating elements 301a, 301b, and 301c and/or relays 304a, 304b, and 304c are OFF in the initial iteration of step 402, the temperature reading is a temperature not resulting from the heating elements, such as room temperature. The control circuit 302 determines, in step 403, whether a heat reduction is necessary, based on a predetermined temperature threshold or acceptable temperature level or range for the current dryer cycle. Acceptable ranges values may be stored in memory based on user selection of one or more cycle types, or may be automatically determined by the dryer control logic based on detected load characteristics.

If a heat reduction is not necessary (No), the circuit control determines in step 404 whether an increase in heat is necessary, based on a predetermined temperature threshold or acceptable temperature level or range. If an increase in heat is not necessary, nothing changes with respect to temperature. However, the control circuit 302 may, at a predetermined or a set period time, return to step 402 to take a temperature reading of the dryer and start the process over from step 402. The values initialized in step 401 are preferably stored in a non-volatile memory so they are maintained from cycle to cycle.

If the circuit control 302 determines in step 404 that a heat increase is necessary (Yes), circuit control 302 further determines whether ActiveHeaters is less than MAX_HEATERS in step 405, where MAX_HEATERS indicates the maximum number of available heating elements. This comparison may be performed by a comparator 306 or other control logic. If ActiveHeaters is not less than MAX_HEATERS (No), nothing changes with respect to temperature (i.e., there are no remaining heaters to turn on). However, the control circuit 302 may, at a predetermined or set period of time, return to step 402 to take a temperature reading of the dryer and start the process over from step 402. On the other hand, if the value of ActiveHeaters is less than MAX_HEATERS, a heater is added as shown in step 406 by performing the AddHeater routine illustrated in and described with respect to FIG. 4B. Adding a heater means that an available heating element is activated, by switching ON its corresponding relay, as described in FIG. 4B.

If in step 403, circuit control 302 determines that a heat reduction is necessary (Yes), the circuit control 302 further determines, in step 407, whether ActiveHeater is greater than zero. This comparison may be performed by a comparator 306 or other control logic. If ActiveHeaters is not greater than zero (No), nothing changes with respect to temperature (i.e., all heaters are already off). However, the control circuit 302 may, at a predetermined or a set time, return to step 402 to take a temperature reading of the dryer system and start the process over from step 402. On the other hand, if ActiveHeaters is greater than zero, a heater is dropped as shown in step 408 by performing the DropHeater subroutine illustrated in and described with respect to FIG. 4C. Dropping a heater means that an available or activated heating element is deactivated by switching OFF its corresponding relay, as described in FIG. 4C.

Each of the processes of steps 406 (AddHeater) and 408 (DropHeater) changes the initial bit assignments of ActivationMask, DeactivationMask, and RelayStatus, as well as the integer value assigned to ActiveHeaters. These changes reflect an update in the number of active heaters, which may increase as a result of AddHeater in step 406 or decrease as a result of DropHeater in step 408. Consequently, the RelayStatus and ActiveHeaters are updated to reflect the relays that are switched ON (as a result of AddHeater) or OFF (as a result of DropHeater). The updated values of some or all of these heater parameters may be published or stored in a memory of the control circuit 302, an external memory module attached to the control circuit 302, or a control module of the heating control system 300 for a possible future use.

With reference to FIG. 4B, and referring to the initialization values of step 401, when a heating element is first added in step 406, the ActivationMask is applied in step 409 to activate the heater corresponding to the bit having value=1. Subsequently, the RelayStatus is updated in step 410 by an OR logic operation of the RelayStatus and the ActivationMask, that is,

RelayStatus=(RelayStatus OR ActivationMask)

The OR logic operation may be performed using OR logic 308, e.g., an OR logic gate, a software OR routine, etc. The ActivationMask is updated in step 411 by rotating the ActivationMask bit values left by one bit, and the ActiveHeaters value is updated in step 412 by incrementing ActiveHeaters by one. In this example, when a heating element is added a first time in step 406, the values of ActivationMask, DeactivationMask, RelayStatus, ActiveHeaters are updated as a result of the method of FIG. 4B to:

$$\begin{matrix}ActivationMask = 001 ( rotated left by one bit ) \\ DeactivationMask = 011 ( unchanged ) \\ RelayStatus = 100 ( 000 OR 100 ) \\ ActiveHeaters = 1 ( incremented by one \text{:} 0 plus 1 )\end{matrix}$$

This update reflects that one relay switch has been turned ON (as a result of the lone 1-bit in the bits values of the RelayStatus) and the number of heaters that are active is one (as a result of the incremented ActiveHeaters by one).

If a second heater is later added according to AddHeater in step 406 the above updated values are again updated as follows:

$$\begin{matrix}ActivationMask = 010 ( rotated left by one bit ) \\ DeactivationMask = 011 ( unchanged ) \\ RelayStatus = 101 ( 100 OR 001 ) \\ ActiveHeaters = 2 ( incremented by one \text{:} 1 plus 1 )\end{matrix}$$

This update reflects that two relay switches have been turned ON (as a result of the two 1-bits in the bits values of the RelayStatus) and the number of heaters that are active is two (as a result of the incremented ActiveHeaters by one).

With reference to FIG. 4C, if a heater is deactivated or dropped according to the DropHeater routine in step 408, the DeactivationMask is applied in step 413 to shut down the heater corresponding to the bit having value=1. Subsequently, the RelayStatus is updated in step 414 by an AND logic operation of the RelayStatus and the Deactivation Mask, that is,

RelayStatus=(RelayStatus AND DeactivationMask)

The AND logic operation may be performed using AND logic 309, e.g., an AND logic gate, a software AND routine, etc. The DeactivationMask is updated in step 415 by rotating the DeactivationMask bit values left by one bit, and the ActiveHeaters mask is updated in step 416 by decrementing its value by one. In this example, when a heater is dropped in step 408, the last updated values of ActivationMask, DeactivationMask, RelayStatus, ActiveHeaters above are updated to:

$$\begin{matrix}ActivationMask = 010 ( unchanged ) \\ DeactivationMask = 110 ( rotated left by one bit ) \\ RelayStatus = 001 ( 101 AND 011 ) \\ ActiveHeaters = 1 ( decremented by one \text{:} 2 minus 1 )\end{matrix}$$

This update reflects that one relay switch has been turned OFF (as a result of a 1-bit in RelayStatus becoming a 0-bit) and the number of heaters that are active is reduced to one (as a result of the decremented ActiveHeaters by one).

In the event of adding a heating element (AddHeater) or dropping a heating element (DropHeater) in the process described above, after a predetermined or set period of time, the process may be repeated from step 402 for a continued temperature regulation of a dryer system, or to achieve a determined temperature threshold or an acceptable temperature level of the dryer system. However, the initialization values of the heating parameters may be replaced by the most recent updated values of the heating parameters. That is, step 401 (initialization of the heating parameters) might be performed at a factory, and the heating parameters are subsequently only changed according to the AddHeater and DropHeater routines as described above. Alternatively, step 401 may be performed at the beginning of each dryer cycle, or may be performed each time the dryer is plugged in or supplied with power (e.g., if maintained in volatile memory). However, such alternatives do not provide as equal commutation distribution as at least storing the ActivationMask in nonvolatile memory, where DeactivationMask can be calculated at the beginning of each dryer cycle as the inverse bitmap of the ActivationMask.

The method illustrated in FIGS. 4A-4C is illustrative only. Other control methods may alternatively be used. The specific control methodology used is secondary to the principle of maintaining substantially equal commutation of relays corresponding to symmetrical heating elements. Some steps may be combined or moved, while some steps may be further split into multiple steps, and yet other steps may be optional.

The control process of FIGS. 4(a)-4(c) discussed above with respect to symmetric heating elements also apply to asymmetrical heating elements as well as a combination of symmetrical and asymmetrical heating elements. The combination of symmetrical and asymmetrical heating elements comprises at least three heating elements, where at least two heating elements are of the same size and at least one heating element is of another size, different from the size of the at least two heating elements of the same size.

When the heating elements 301a, 301b, and 301c included in the heating control system 300 are all asymmetrical to each other, and the current temperature is below a desired temperature range, the heating control system 300 determines whether any of the asymmetrical heating elements is in an OFF state. Upon determining that at least one of the asymmetrical heating elements is in an OFF state, the heating control system determines one of the heating elements to activate, based on a desired or set temperature range or threshold and the sizes of the asymmetrical elements in the OFF state. The determined heating element that is activated is the one that is configured to supply heat at a temperature closest to the difference between the desired temperature and the current temperature.

When heating elements are all asymmetric to each other and the current temperature is above a desired temperature range, the heating control system 300 determines whether any of the asymmetrical heating elements is in an ON state. Upon determining that at least one of the asymmetrical heating elements is in an ON state, the heating control system determines one of the heating elements to deactivate, based on a desired or set temperature range or threshold and the sizes of the activated asymmetrical elements. The determined heating element that is deactivated is the one that is supplying heat at a temperature closest to the difference between the desired temperature and the current temperature.

When the heating elements 301a, 301b, and 301c included in the heating control system 300 are a combination of symmetrical and asymmetrical, in this example two symmetrical heating elements and one asymmetrical heating element, and the current temperature is below a desired temperature range, the heating control system 300 determines whether any of the heating elements is in an OFF state. Upon determining that at least one of the heating elements is in an OFF state, the heating control system determines one of the heating elements in the OFF state to activate, based on a desired or set temperature range or threshold and the sizes of the elements in the OFF state. The determined heating element that is activated is the one that is configured to supply heat at a temperature closest to the difference between the desired temperature and the current temperature. If at least two symmetrical heating element in an OFF state are each configured to supply heat at a temperature closest to the difference between a desired temperature and the current temperature, one of the at least two symmetrical heating elements is selected and activated.

When heating elements are a combination of symmetrical and asymmetrical heating elements and the current temperature is above a desired temperature range, the heating control system 300 determines whether any of the heating elements is in an ON state. Upon determining that at least one of the heating elements is in an ON state, the heating control system determines one of the heating elements in the ON state to deactivate, based on a desired or set temperature range or threshold and the sizes of the activated heating elements. The determined heating element that is deactivated is the one that is supplying heat at a temperature closest to the difference between the desired temperature and the current temperature. If at least two symmetrical heating element in an ON state are each supplying heat at a temperature closest to the difference between a desired temperature and the current temperature, one of the at least two symmetrical heating elements is selected and activated.

In the absence of using the control method described with respect to FIG. 4, a TRIAC (TRIode for Alternating Current) or IGBT (Insulated Gate Bipolar Transistor) control method may be used for controlling the relay ON/OFF control of the heating elements, particularly for a case of using a plurality of symmetric heating elements. Alternatively, a combination of TRIAC or IGBT and a relay ON/OFF control is used for controlling a plurality of heating elements. The TRIAC and IGBT control method uses a TRIAC control circuit and an IGBT control circuit, respectively.

One or more aspects of the invention may be embodied in computer-usable data and computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects of the invention, and such data structures are contemplated within the scope of computer executable instructions and computer-usable data described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A method of controlling symmetrical heating elements in a laundry dryer system comprising:
(a) initializing heating system parameters corresponding to a plurality of symmetrical heating elements, said heating system parameters comprising a heater activation parameter storing information usable to ensure substantially equal activation of each symmetrical heating element;
(b) reading a current temperature of the laundry dryer system;
(c) when the current temperature is below a desired temperature range and at least one of the plurality of symmetrical heating elements is OFF, activating an available heating element selected from the at least one of the plurality of symmetrical heating elements, said activation being based on the heater activation parameter to maintain substantially equal activation of each symmetrical heating element; and
(d) when the current temperature is above the desired temperature range and at least one of the plurality of symmetrical heating elements is ON, determining which of the at least one of the plurality of symmetrical heating elements that is ON has been ON a longest period of time in its current ON state, and deactivating the determined one of the plurality of symmetrical heating elements.

2. The method of claim 1, further comprising repeating steps (b)-(d) in intervals of a predetermined amount of time.

3. The method of claim 1, wherein said method further comprises maintaining a plurality of relay switches, each corresponding to one of the plurality of heating elements, such that the relay switches are commuted a substantially equal number of times over the lifespan of each of the plurality of relay switches.

4. The method of claim 1, wherein step (a) is performed only once, subsequent to manufacture of the laundry dryer system.

5. The method of claim 1, wherein step (a) is performed once after each time the laundry dryer system is plugged in.

6. The method of claim 1, wherein step (a) is performed once per cycle of the laundry dryer system.

7. The method of claim 1, wherein the heater activation parameter comprises an activation bitmap.

8. The method of claim 7, wherein the heater system parameters comprise a deactivation bitmap, an active heater bitmap, and an integer active heater count.

9. The method of claim 8, wherein selecting an available heating element comprises:
applying the activation bitmap to the active heater bitmap using an OR logic operation to determine a new active heater bitmap, and activating any heater not already activated that corresponds to a true bit value of the new active heater bitmap; and
rotating the activation bitmap one bit.

10. The method of claim 8, wherein determining the one of the plurality of symmetrical heating elements to turn OFF comprises:
applying the deactivation bitmap to the active heater bitmap using an AND logic operation to determine a new active heater bitmap, and deactivating any heater that is ON that corresponds to a false bit value of the new active heater bitmap; and
rotating the deactivation bitmap one bit.

11. A laundry dryer, comprising:
a processor controlling operations of the dryer;
memory storing computer executable instructions that, when executed by the processor, cause the laundry dryer to perform a method comprising:
(a) initializing heating system parameters corresponding to a plurality of symmetrical heating elements, said heating system parameters comprising a heater activation parameter storing information usable to ensure substantially equal activation of each symmetrical heating element;
(b) reading a current temperature of the laundry dryer system;
(c) when the current temperature is below a desired temperature range and at least one of the plurality of symmetrical heating elements is OFF, activating an available heating element selected from the at least one of the plurality of symmetrical heating elements, said activation being based on the heater activation parameter to maintain substantially equal activation of each symmetrical heating element; and
(d) when the current temperature is above the desired temperature range and at least one of the plurality of symmetrical heating elements is ON, determining which of the at least one of the plurality of symmetrical heating elements that is ON has been ON a longest period of time in its current ON state, and deactivating the determined one of the plurality of symmetrical heating elements.

12. The laundry dryer of claim 11, further comprising repeating steps (b)-(d) in intervals of a predetermined amount of time.

13. The laundry dryer of claim 11, wherein said method further comprises maintaining a plurality of relay switches, each corresponding to one of the plurality of heating elements, such that the relay switches are commuted a substantially equal number of times over the lifespan of each of the plurality of relay switches.

14. The laundry dryer of claim 11, wherein step (a) is performed only once, subsequent to manufacture of the laundry dryer system.

15. The laundry dryer of claim 11, wherein step (a) is performed once after each time the laundry dryer system is plugged in.

16. The laundry dryer of claim 11, wherein step (a) is performed once per cycle of the laundry dryer system.

17. The laundry dryer of claim 11, wherein the heater activation parameter comprises an activation bitmap.

18. The laundry dryer of claim 17, wherein the heater system parameters comprise a deactivation bitmap, an active heater bitmap, and an integer active heater count.

19. The laundry dryer of claim 18, wherein selecting an available heating element comprises:
applying the activation bitmap to the active heater bitmap using an OR logic operation to determine a new active heater bitmap, and activating any heater not already activated that corresponds to a true bit value of the new active heater bitmap; and
rotating the activation bitmap one bit.

20. The laundry dryer of claim 18, wherein determining the one of the plurality of symmetrical heating elements to turn OFF comprises:
applying the deactivation bitmap to the active heater bitmap using an AND logic operation to determine a new active heater bitmap, and deactivating any heater that is ON that corresponds to a false bit value of the new active heater bitmap; and
rotating the deactivation bitmap one bit.

21. The laundry dryer of claim 11, wherein the plurality of symmetrical heating elements comprises at least three symmetrical heating elements.

22. A laundry dryer, comprising:
a processor controlling operations of the dryer;
memory storing computer executable instructions that, when executed by the processor, cause the laundry dryer to perform a method comprising:
(a) initializing heating system parameters corresponding to a plurality of asymmetrical heating elements, said heating system parameters comprising a heater activation parameter;
(b) reading a current temperature of the laundry dryer system;
(c) when the current temperature is below a desired temperature range and at least one of the plurality of asymmetrical heating elements is in an OFF state, determining from the at least one of the plurality of asymmetrical heating elements in the OFF state, the heating element that is configured to supply heat at a temperature closest to the difference between a desired temperature and the current temperature, activating the determined one of the plurality of asymmetrical heating elements in the OFF state; and
(d) when the current temperature is above the desired temperature range and at least one of the plurality of asymmetrical heating elements is in an ON state, determining which of the at least one of the plurality of symmetrical heating elements in the ON state is supplying heat at a temperature closest to the difference between a desired temperature and the current temperature, and deactivating the determined one of the plurality of ON state asymmetrical heating elements.

23. A method of controlling a combination of symmetrical and asymmetrical heating elements in a laundry dryer system comprising:
(a) initializing heating system parameters corresponding to a combination of symmetrical and asymmetrical heating elements, said heating system parameters comprising a heater activation parameter, wherein the combination of symmetrical and asymmetrical heating elements includes at least two heating elements each having an equal first size and at least one heating element each with a second size different from the first size;
(b) reading a current temperature of the laundry dryer system;
(c) when the current temperature is below a desired temperature range and at least one of the heating elements is in an OFF state, determining and selecting a heating element in the OFF state that is configured to supply heat at a temperature closest to the difference between a desired temperature and the current temperature, and activating the selected heating element in the OFF state; and
(d) when the current temperature is above the desired temperature range and at least one of the heating elements is an ON state, determining and selecting a heating element in the ON state that is supplying heat at a temperature closest to the difference between a desired temperature and the current temperature, and deactivating the selected heating element in the ON state.

24. The method of claim 23, wherein if in step (c) at least two symmetrical heating elements in the OFF state are configured to supply heat at a temperature closest to the difference between a desired temperature and the current temperature, one of the at least two symmetrical heating elements is selected to maintain substantially equal commutation of each heating element.

25. The method of claim 23, wherein if in step (d) at least two symmetrical heating elements in the ON state are supplying heat at a temperature closest to the difference between a desired temperature and the current temperature, one of the at least two symmetrical heating elements is selected to maintain substantially equal commutation of each heating element.
